(19) United States
(12) Patent Application Publication
(10) Pub. No.: US 2017/0116875 A1
(43) Pub. Date: Apr. 27, 2017

(54) Table-Top Cognitive Kinesthetic Learning Enhancement Device and Method

(71) Applicant: Kevin D. McGuire, Pittsburgh, PA (US)

(72) Inventor: Kevin D. McGuire, Pittsburgh, PA (US)

(21) Appl. No.: 15/331,856

(22) Filed: Oct. 22, 2016

Related U.S. Application Data
(60) Provisional application No. 62/245,582, filed on Oct. 23, 2015.

(51) Int. Cl. G09B 17/00; B43L 1/00

(52) U.S. Cl. CPC G09B 17/00; B43L 1/00

(57) ABSTRACT

The present invention provides a cognitive-kinesthetic device and method which enhances, facilitates and accelerates cognitive development and learning in school-age children by coupling the learning process with movement, referred to as “kinesthetic learning.” The device and method is contemplated for use in school-age children ranging in age from four to twelve years old. Regardless of the age of the children, the invention provides that playing the physically active cognitive-kinesthetic game will enhance, facilitate and accelerate cognitive development and learning in school-age children, such as reading, verbal fluency, math, science, spatial relationships and other fields of knowledge, while at the same time providing a fun and exciting experience. In addition, the coupling of movement with the learning process provides a calming effect to school-age children so that they are able to pay better attention during the learning process.

### CROSS REFERENCE TO RELATED APPLICATIONS

The present application claims priority to U.S. Provisional Application No. 62/245,582, filed Oct. 23, 2015, which is incorporated herein by reference in its entirety.

### FIELD OF THE INVENTION

The present invention relates to enhancing learning skills in children and, in particular, to a cognitive-kinesthetic game and method of use which enhances, facilitates and accelerates cognitive development and learning skills in school-age children.

### BACKGROUND OF THE INVENTION

Humans have five senses: vision, hearing, taste, smell and touch. Psychologists have distilled these five senses into three “sensory modalities” which have been shown to be particularly relevant to learning: verbal, visual, and kinesthetic. We learn through our verbal, visual, and kinesthetic sensory modalities, and our memories are encoded in these different formats. It is known that each person typically favors one style of learning over the others. For example, verbal learners are best at absorbing written and spoken information; visual learners digest information from charts, diagrams, timelines, maps, and other concrete images more easily than from the written or spoken word; and kinesthetic learners enjoy hands-on activities involving movement, such as dancing, athletics and other physical activities.

It has been known for many years that activating the body activates the brain. In particular, it has been shown that literacy skills such as semantic fluency, verbal fluency, and phonemic awareness improve significantly after an exercise program. It also has been shown that for students with a sensory-integration dysfunction, kinesthetic, i.e., movement, therapies improved cognitive, i.e., learning, skills. Further, it has been shown that in elementary-age at-risk children, incorporating kinesthetics while being taught writing, reading and spelling resulted in these children matching or surpassing a similar cohort of non-risk students. This increase in academic performance was shown to be especially noticeable for word skills.

It is well known that in today's elementary school classrooms, there is a lack of active play and movement while learning, as most of the time students are seated at their desks. Research has shown that children learn faster and easier when their learning is connected to a physical activity. Today, many of our traditional classrooms offer little or no physical activity, with students typically sitting in their seats for hours and listening passively to their teachers. Thus, students often resort to tapping on their desks, moving their feet or bothering their classmates to release some of their pent-up energy. There is a need, therefore, for students to be able to release their energy in active play and movement while learning at the same time. Thus, there exists a need to provide a learning experience for school-age children that synthesizes learning with physical activity, referred to herein as a “cognitive-kinesthetic” learning experience, in an engaging, fun and exciting manner, which would be an advantageous and needed advance in the educational curriculum of school-age children.

### SUMMARY OF THE INVENTION

The present invention fulfills this need by providing a table-top cognitive-kinesthetic device and method which enhances, facilitates and accelerates learning skills and cognitive ability of school-age children by coupling learning with movement, referred to as “kinesthetic learning,” while making the learning process exciting and fun.

In an aspect of the invention, there is provided a cognitive-kinesthetic device for enhancing, facilitating and accelerating learning skills in children. The device comprises a first vertical pole, a second vertical pole, and a horizontal pole, the first and second vertical poles and the horizontal pole each having a first end and a second end; a first pole connector and a second pole connector, the first end of the first vertical pole inserting into one end of the first pole connector, the first end of the horizontal pole inserting into the other end of the first pole connector, the first end of the second vertical pole inserting into one end of the second pole connector and the second end of the horizontal pole inserting into the other end of the second pole fitting; a first pole attachment means and a second pole attachment means, the second end of the first vertical pole connected to the first pole attachment means, and the second end of the second vertical pole connected to the second pole attachment means, the first and second pole attachment means securing the first and second vertical poles to a horizontal surface; a banner having a first end and a second end, and a first side and a second side, the first and second sides of the banner having a surface displaying two or more learning goals in the form of letters, numbers, words, symbols and/or pictures; a first banner attachment means and a second banner attachment means, the first banner attachment means attaching the first end of the banner to the first vertical pole, and the second banner attachment means attaching the second end of the banner to the second vertical pole; and an elastic cord or string having a first end and a second end, the first end of the cord or string attached to the horizontal rod, and the second end of the cord or string attached to an inflatable object.

In another aspect of the invention, there is provided a cognitive-kinesthetic method for enhancing, facilitating and accelerating learning skills and cognitive ability in children. The method comprises having a first player and a second player play a cognitive-kinesthetic game using the cognitive-kinesthetic device described above, the cognitive-kinesthetic game comprising: (a) having an individual, such as a teacher, instructor or parent, place an identical set of about two to about twenty learning goals on the first side and the second side of the banner; (b) positioning the first player on the first side of the banner and the second player on the second side of the banner; (c) having the first player respond to the first learning goal, the response comprising reading the one or more words, dolch sight words or foreign words; solving the mathematical problem or answering the question contained in the first learning goal, and then having the first player hit or throw the inflatable object over the banner to the second player; (d) having the second player respond to the next learning goal, and then having the second player hit or throw the inflatable object over the banner to the first player; (e) having the first player respond to the next learning goal, and then hit or throw the inflatable object over the banner to the second player; and (f) repeating steps (d) and (e) until the first player and the second player have responded to some or all of the learning goals.

The cognitive-kinesthetic method further comprises having the individual determine whether the response given by the first or second player is correct, and when the response is not correct, then giving the other player a chance to respond to the same learning goal.

The cognitive-kinesthetic method further comprises adding a third player on the side of the first player to form a first team, and adding a fourth player on the side of the second player to form a second team, each of the four players given a turn to respond to a learning goal, and then hitting or throwing the inflatable object over the banner to the players on the other side.

The cognitive-kinesthetic method further comprises that when the response to a learning goal is incorrect by one of the players, then giving another player from the same team or from the other team a chance to respond to the same learning goal.

### BRIEF DESCRIPTION OF THE DRAWINGS

A fuller understanding of the invention can be gained from the following description when read in conjunction with the accompanying figures, where like reference numerals refer to identical or functionally similar elements throughout the separate views, which illustrate some, but not the only and exclusive, examples of embodiments of the invention and, as such, the figures disclosed herein are to be considered illustrative rather than limiting. In the drawings

FIG. 1 shows the cognitive-kinesthetic device in accordance with embodiments of the invention;

FIG. 2 shows the cognitive-kinesthetic device in use by two players in accordance with embodiments of the invention; and

FIG. 3 shows the cognitive-kinesthetic device in use by four players in accordance with embodiments of the invention.

### DETAILED DESCRIPTION OF THE INVENTION

The cognitive-kinesthetic device and method which enhances, facilitates and accelerates learning skills and cognitive abilities of school-age children by coupling the learning process with movement, i.e. “kinesthetic learning,” is described in detail below.

As used herein, “cognition” and “cognitive process” are meant to be interchangeable, with both terms defined herein as the mental action or process of acquiring knowledge and understanding through thought, experience, and the senses.

As used herein, “cognition” and “learning” is meant to be interchangeable.

As used herein, “cognitive ability” is defined as the capacity to perform higher mental processes of reasoning, remembering, understanding, and problem solving.

As used herein, “cognitive performance” is defined herein as the measurable or observable outcome of the cognitive process.

As used herein, “kinesthetics” is defined herein as muscular movement in response to visual, auditory, and tactile stimulation.

As used herein, “learning skills” is defined as the skills needed to process, understand, remember and apply the knowledge, skills and information given to them in an instructional setting, such as at school.

As used herein, “muscular movement” is defined herein as gross motor activity or fine motor activity.

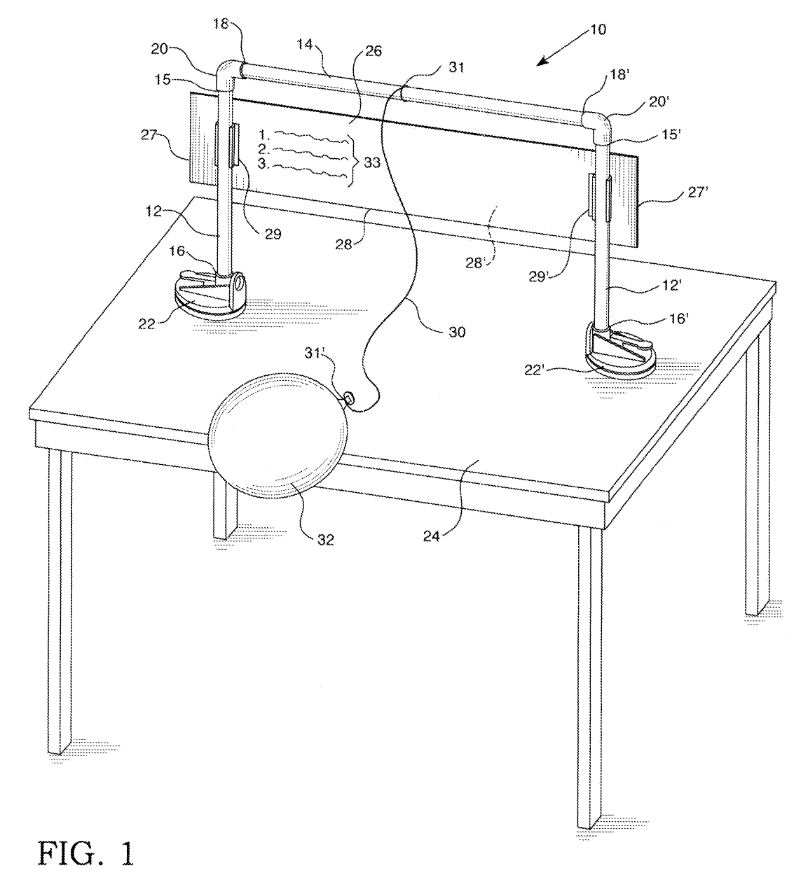

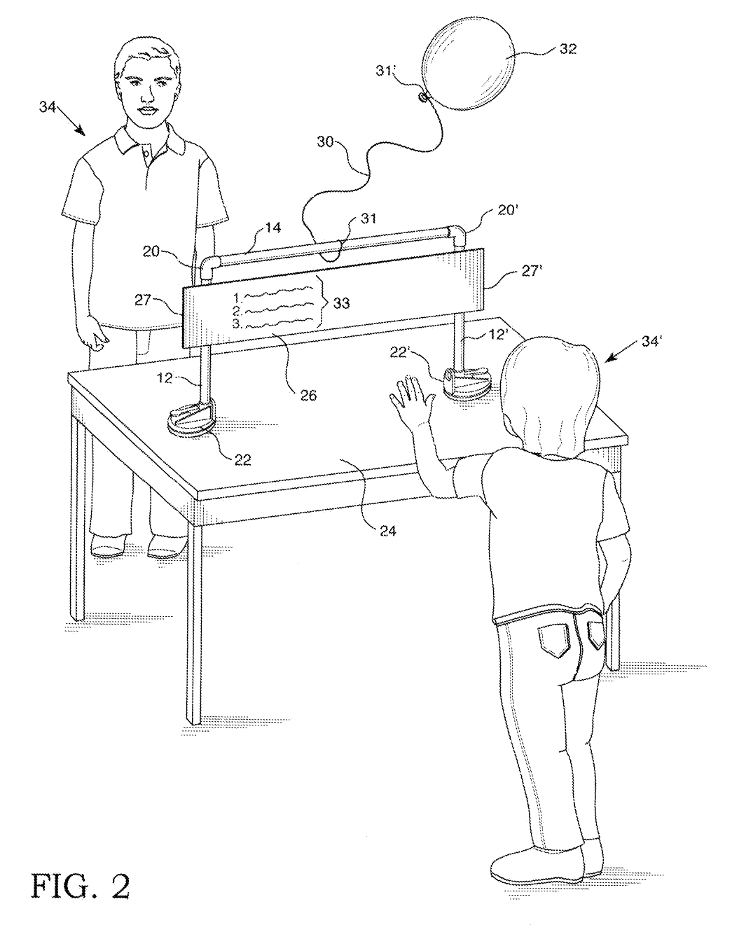

Referring now to FIGS. 1 and 2, the present invention provides a cognitive-kinesthetic device 10 and method of use for enhancing, facilitating and accelerating learning skills and cognitive ability in school-age children.

As shown in FIG. 1, the device 10 comprises a first vertical pole 12, a second vertical pole 12′ and a horizontal pole 14. The first 12 and second 12′ vertical poles, and the horizontal pole 14 each has a first end 15, 15′, 18 and a second end 16, 16′, 18′. The first end 15 of the first vertical pole 12 fits into one end of a first pole connector 20, the first end 18 of the horizontal pole 14 fits into the other end of the first pole connector 20, the first end 15′ of the second vertical pole 12′ fits into one end of a second pole connector 20′, and the second end 18′ of the horizontal pole 14 fits into the other end of the second pole connector 20.

The second end 16 of the first vertical pole 12 is attached to a first pole attachment means 22, and the second end 16′ of the second vertical pole 12′ is attached to a second pole attachment means 22′. The first and second attachment means 22, 22′ are securely attached to a horizontal surface 24, such as a floor, the top of a desk or the top of a table.

The device includes a banner 26 having a first end 27, a second end 27′, a first side 28 and a second side 28′. The first end 27 of the banner 26 is attached to the first end 15 of the first vertical pole 12 with a first removable banner attachment means 29, and the second end 27′ of the banner 26 is attached to the first end 15′ of the second vertical pole 12′ with a second removable banner attachment means 29′. The first and second sides 28, 28′ of the banner 26 is constructed of a surface in which each of the first and second sides 28, 28′ displays an identical set of learning goals (33) in the form of letters, numbers, words, symbols and/or pictures which can easily be removed and replaced by other letters, numbers, words, symbols and/or pictures. A first end 31 of an elastic cord or string 30 is tied around the center of the horizontal pole 14, and a second end 31′ of the elastic cord or string is attached to an inflatable object 32.

In an embodiment, the inflatable object is a latex balloon filled with air. The size of the balloon may range from about 5.0 inches diameter to about 12.0 inches in diameter. In an embodiment, the diameter of the balloon is about 10.0 inches.

Any suitable elastic cord or string may be used in accordance with the invention, including but not limited to an elastic braided or twisted material such as elastic braided or twisted cotton, nylon, rayon, polyester, natural rubber, synthetic rubber and polypropylene. In an embodiment, the elastic cord or string has a length ranging from about 12.0 inches to about 120.0 inches in length. In another embodiment, the elastic cord or string is about 36.0 inches in length.

The first and second removable banner attachment means 29, 29′ may be constructed from Velcro tape or straps, or any other removable attachment device or hook and loop fastener attachment capable of attaching and detaching the banner 26 to the vertical poles 12, 12′.

The banner 26 may be made of any suitable white cardstock paper of any suitable weight including, but not limited to, sixty-five pound cover stock, so long as the banner 26 is made from an erasable material which allows for writing of the learning goals 33 thereon, and then erasing the learning goals 33 so that another set of learning goals can be written thereon. In an embodiment, the white cardstock paper may be laminated with plastic on its first and second sides which allows easy and removable writing of letters, numbers, words, symbols and/or pictures 33 thereon with an erasable dry eraser marker, pen or pencil.

In an embodiment, the learning goals 33 are placed on the first and second sides 28, 28′ of the banner 26 by an individual, such as a teacher, instructor or parent, who writes them on the banner 26 with an erasable marker, pen or pencil.

In another embodiment, the first and second sides 28, 28′ of the banner 26 comprises an electronic light emitting diode (LED) flat panel display board which displays the identical set of learning goals 33 on each side 28, 28′. Any suitable LED display board with the dimensions described herein for the banner 26 may be used in accordance with the invention. In an embodiment, the electronic LED display board is programmable so that the individual can program the LED display board to display sequentially more than one series of two to about twenty learning goals.

In an embodiment, the learning goals 33 that are displayed include, without limitation, one or more words, dolch sight words, foreign words, mathematical problems consisting of addition, subtraction, multiplication or division of one or more digits, scientific terms, foreign language words, geography questions, history questions or any other elementary school curriculum questions.

The banner has a length that can range from about 12.0 inches to about 36.0 inches, and a width that can range from about 3.0 inches to about 12.0 inches. In an embodiment, the banner has a length of about 26.0 inches and a width of about 7.0 inches.

The length of the vertical poles can range from about 10.0 inches to about 24.0 inches, with a diameter that can range from about 0.5 inches to about 0.75 inches. In an embodiment, the length of the vertical poles is about 16.0 inches long and the diameter is about 0.5 inches.

The length of the horizontal pole can range from about 15.0 inches to about 36.0 inches, with a diameter that can range from about 0.5 inches to about 0.75 inches. In an embodiment, the length of the horizontal pole is about 24.0 inches long and the diameter is about 0.5 inches.

In an embodiment, the space between the vertical poles ranges from about 12.0 inches to about 48.0 inches. In another embodiment, the space between the two vertical poles is about 24.0 inches.

Any suitable pole attachment means commonly known and used to secure poles with the dimensions described herein to surfaces may be used in accordance with the invention, such as a suction cup device containing a circular opening which accepts insertion of one end of a pole in order to secure the pole to a surface via suction.

Any suitable material may be used to manufacture the vertical poles in accordance with the invention, including but not limited to a polymeric material such as a PVC pole.

In another aspect of the invention, there is provided a cognitive-kinesthetic method for enhancing, facilitating and accelerating learning skills and cognitive ability in children. Referring to FIG. 2, the method comprises having a first player 34 and a second player 34′ play a cognitive-kinesthetic game using the cognitive-kinesthetic device 10. The cognitive-kinesthetic game comprises (a) having the individual place the identical set of about two to about twenty learning goals 33 on the first side 28 and the second side 28′ of the banner 26, (b) positioning the first player 34 on the first side 258 of the banner 26 and the second player 34′ on the second side 28′ of the banner 26; (c) having the first player 34 respond verbally to the first learning goal. The response comprises reading the one or more words, dolch sight words, or foreign language words; solving the mathematical problems consisting of addition, subtraction, multiplication or division of one or more digits; or answering the questions regarding science, geography, social studies, history or other elementary school curriculum questions; and then having the first player 34 hit or throw the inflatable object 32 over the banner 26 to the second player 34′; (d) having the second player 34′ respond to the next learning goal, and then having the second player 34′ hit or throw the inflatable object 32 over the banner 26 to the first player 34; (e) having the first player 34 respond to the next learning goal, and then having the first player 34 hit or throw the inflatable object 32 over the banner 26 to the second player 34′; and (f) repeating steps (d) and (e) until the first and second players 34, 34′ have responded to some or all of the learning goals 33.

The cognitive-kinesthetic method further comprises having the individual determine whether the response given by each of the first and second players 34, 34′ is correct, and when it is not correct, then giving the other player a chance to respond to the same learning goal.

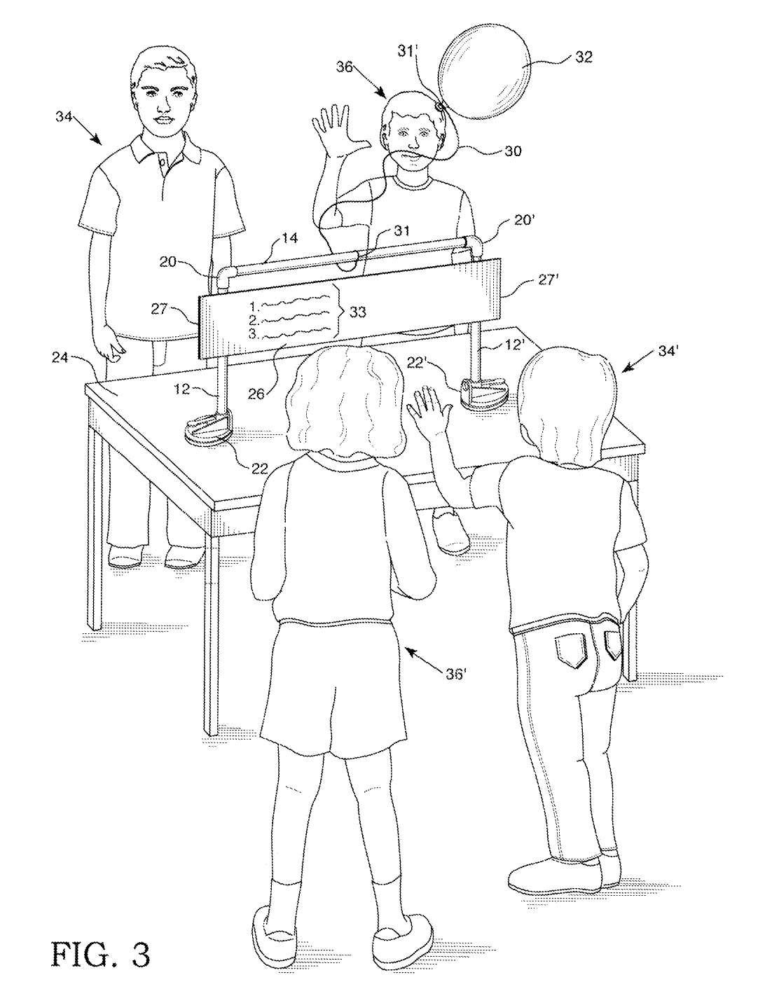

As shown in FIG. 3, the cognitive-kinesthetic method further comprises adding a third player 36 on the side of the first player 34 to form a first team, and adding a fourth player 36′ on the side of the second player 34′ to form a second team, each of the four players 34, 34′, 36, 36′ given a turn to respond to a learning goal, and then hitting or throwing the inflatable object 32 over the banner 26 to the players on the other side.

The cognitive-kinesthetic method further comprises that when the response to a learning goal is incorrect by one of the players, then giving another player from the same team or from the other team a chance to respond to the same learning goal.

The cognitive-kinesthetic method further comprises scoring one point if the response given by a player is correct, and at the end of the game, if the players are tied in points, then having the individual add one or more bonus learning goals until the tie is broken.

The invention contemplates that the cognitive-kinesthetic game has a set time limit in which the players have to respond to each of the learning goals.

The cognitive-kinesthetic device and method of the invention is contemplated for use in school-age children ranging in age from four years to twelve years old. Regardless of the age of the children, the invention provides that playing the cognitive-kinesthetic game will enhance, facilitate and accelerate cognitive ability and learning skills in school-age children, such as verbal fluency, reading, math, science, spatial relationships and other fields of knowledge, as well as provide a calming effect to school-age children so that they to pay better attention during the learning process, due to the coupling of physical activity with the learning process.

Further, the invention contemplates that the specific rules of the cognitive-kinesthetic game be extremely flexible, so that the rules can be made up anew by teachers, instructors or parents depending on the age of the children, the physical ability of the children playing the game, and the learning goals desired to be obtained by the children. Thus, the cognitive-kinesthetic device and method of the invention may be analogized to a deck of cards; and the method of the invention may be analogized to the infinite number of games that can be played with the deck of cards. In a similar manner, the cognitive-kinesthetic method of the invention can have a set of rules created by the teacher, instructor or parent which is appropriate for the age of the children playing the game and the desired learning goals of the teacher, instructor or parent, and which can be changed easily to accommodate the individuality of the players. Inherent in the device and method of the invention, however, are two constants that are unchangeable: the synthesis of the learning process regarding school curriculum in children with concomitant kinesthetic movement of the children so that the learning process is enhanced, facilitated and accelerated while at the same time making the learning process exciting and fun.

The present invention is more particularly described in the following non-limiting examples, which are intended to be illustrative only, as numerous modifications and variations therein will be apparent to those skilled in the art.

### EXAMPLE 1

### Cognitive-Kinesthetic Game with Two Second Grade Players

Two children in second grade, both seven years old, are picked by the teacher to play the cognitive-kinesthetic game, referred to as the “brainy-ball” game, in accordance with the device and method of the invention. The two players go to opposite sides of the device, which is attached to a table-top in front of the classroom.

The teacher writes the following dolch sight words shown below on both sides of the banner of the device with an erasable marker. The banner is made of a white cardstock material.

| | |
|---|---|
| 1. | Sleep |
| 2. | Always |
| 3. | Right |
| 4. | Those |
| 5. | Found |
| 6. | Wash |
| 7. | Which |
| 8. | Sing |
| 9. | These |
| 10. | Goes |

The teacher goes over the rules of the game, which consists of each player to state a word on the board starting with the first word and then hitting or throwing the balloon over the banner to the other player. A correct answer is worth one point. If the answer is incorrect, then the other player is given a chance to state that word correctly. The player with the most points wins. The teacher then states that when she says “Start,” the player on the left of the device, (as seen by the other children in the classroom), referred to as the first player, will begin the game.

The teacher says “Start” and the game begins.

### EXAMPLE 2

### Cognitive-Kinesthetic Game with Two Third Grade Players

Two children in third grade, both eight years old, are picked by the teacher to play the cognitive-kinesthetic game, referred to as the “brainy-ball” game, in accordance with the device and method of the invention.

The teacher programs an electronic LED display board to display three series of ten multiplication problems each on each side of the board.

The teacher goes over the rules of the game, which consists of each player solving a multiplication problem shown on the display board and then hitting or throwing the balloon over the banner to the other player. A correct answer is worth one point. If the answer is incorrect, then the other player is given a chance to solve the multiplication problem. There are three rounds in the game. The player winning the most rounds wins the round.

The teacher then states that when she says “Start,” the player on the left of the device, (as seen by the other children in the classroom), referred to as the first player, will begin the game.

The teacher says “Start” and the game begins. The game proceeds until the first series of multiplication problems are finished. The teacher uses a remote control to switch to the second series of multiplication problems, and then states “Start” to begin the second round of the game. The game proceeds until the second series of multiplication problems are finished. The teacher uses a remote control to switch to the third series of multiplication problems, and then states “Start” to begin the third round of the game.

### EXAMPLE 3

### Cognitive-Kinesthetic Game with Four Second Grade Players

Four children in second grade, all seven years old, are picked by the teacher to play the cognitive-kinesthetic game, referred to as the “brainy-ball” game, which is attached to a desk, in accordance with the device and method of the invention. Two players go to one side of the device, referred to as the first and second players, or team one, and the other two players go to the other side of the device, referred to as the third and fourth players, or team two.

The teacher writes the following dolch sight words shown below on both sides of the banner of the device with an erasable marker. The banner is made of a white cardstock material.

| | |
|---|---|
| 1. | Sleep |
| 2. | Always |
| 3. | Right |
| 4. | Those |
| 5. | Found |
| 6. | Wash |
| 7. | Which |
| 8. | Sing |
| 9. | These |
| 10. | Goes |
| 11. | Best |
| 12. | Call |
| 13. | Wish |
| 14. | Pull |
| 15. | Don't |
| 16. | Fast |
| 17. | Their |
| 18. | Buy |
| 19. | First |
| 20. | Around |

The teacher goes over the rules of the game, which consists of each player having a turn to state a word and then hit or throw the balloon over the banner to the other side. The sequence of player turns consists of (1) the first player, (2) the third player, (3) the second player, and (4) the fourth player. A correct answer is worth one point. If the answer is incorrect, then the next player that is up is given a chance to state that word correctly. The team with the most points wins.

The teacher then states that when she says “Start,” the first player will begin the game.

The teacher says “Start” and the game begins.

While the invention has been particularly shown and described with reference to embodiments described above, it will be understood by those skilled in the art that various alterations in form and detail may be made therein without departing from the spirit and scope of the invention, as defined by the appended claims.

What is claimed is:

1. A cognitive-kinesthetic device for enhancing, facilitating and accelerating learning skills in children, comprising:
a first vertical pole, a second vertical pole, and a horizontal pole, said first and second vertical poles and said horizontal pole each having a first end and a second end;
a first pole fitting and a second pole fitting, said first end of said first vertical pole fitting into one end of the first pole fitting, said first end of said horizontal pole fitting into the other end of the first pole fitting, said first end of said second vertical pole fitting into one end of the second pole fitting and said second end of the horizontal pole fitting into the other end of the pole fitting;
a first pole attachment means and a second pole attachment means, said second end of the first vertical pole securely connected to the first pole attachment means, and said second end of the second vertical pole securely connected to the second pole attachment means, said first and second pole attachment means securing the first and second vertical poles to a horizontal surface;
a banner having a first end and a second end and a first side and a second side, said first side and said second side of the banner having a surface, each surface displaying an identical set of about two to about twenty learning goals in the form of letters, numbers, words, symbols and/or pictures;
a first banner attachment means and a second banner attachment means, said first banner attachment means attaching the first end of the banner to the first vertical pole, and said second banner attachment means attaching the second end of the banner to the second vertical pole; and
a cord having a first end and a second end, said first end of the cord attached to the horizontal rod, and said second end of the cord attached to an inflatable object.

2. The cognitive-kinesthetic device of claim 1, wherein the banner is comprised of white cardstock laminated with plastic which allows erasable writing of the identical set of about two to about twenty learning goals on the first and second sides of the banner with an erasable marker, pen or pencil. and digitally display on an electronic LED display board.

3. The cognitive-kinesthetic device of claim 1, wherein the banner comprises an electronic LED display board on the first and second sides of the banner so that the identical set of learning goals are digitally displayed thereon.

4. The cognitive-kinesthetic device of claim 3, wherein the electronic LED display board is programmable so that more than one set of two to about twenty learning goals can be displayed sequentially.

5. The cognitive-kinesthetic device of claim 1, wherein the about two to about twenty learning goals is selected from the group consisting of one or more words, dolch sight words, or foreign language words; mathematical problems consisting of addition, subtraction, multiplication or division of one or more digits; and questions regarding science, geography, social studies, history or other elementary school curriculum questions.

6. The cognitive-kinesthetic device of claim 1, wherein each of the first and second pole attachment means is a suction cup device having an opening for inserting the first vertical pole and the second vertical pole therein, respectively.

7. The cognitive-kinesthetic device of claim 1, wherein the cord is comprised of an elastic braided or twisted material selected from the group consisting of cotton, nylon, rayon, polyester, natural rubber, synthetic rubber and polypropylene.

8. The cognitive-kinesthetic device of claim 1, wherein the inflatable object is a latex balloon filled with air.

9. A cognitive-kinesthetic method for enhancing, accelerating and facilitating learning skills in children, said method comprising:
having a first player and a second player play a cognitive-kinesthetic game using the device of claim 1, said cognitive-kinesthetic game comprising:
(a) having an individual place the between the identical set of two and twenty learning goals on the first side and the second side of the banner;
(a) positioning the first player on the first side of the banner and the second player on the second side of the banner;
(c) having the first player verbally respond to the first learning goal, said response comprising reading the one or more words, solving the mathematical problem or answering the question contained in the first learning goal, and then having the first player hit or throw the inflatable object over the banner to the second player;
(d) having the second player respond to the next learning goal, and then having the second player hit or throw the inflatable object over the banner to the first player;
(e) having the first player respond to the next learning goal, and then hit or throw the inflatable object over the banner to the second player; and
(f) repeating steps (d) and (e) until the first player and the second player have responded to some or all of the learning goals.

10. The cognitive-kinesthetic method of claim 9, further comprising having the individual determine whether the response given by each of the first and second players is correct, and when it is not correct, then giving the other player a chance to respond to the same learning goal.

11. The cognitive-kinesthetic method of claim 9, wherein the individual is a teacher, instructor or parent.

12. The cognitive-kinesthetic method of claim 9, further comprising adding a third player on the side of the first player to form a first team, and adding a fourth player on the side of the second player to form a second team, each of the four players given a turn to respond to a learning goal, and then hitting or throwing the inflatable object over the banner to the players on the other side.

13. The cognitive-kinesthetic method of claim 12, further comprising that when the response to a learning goal is incorrect by one of the players, then giving another player from the same team or from the other team a chance to respond to the same learning goal.

14. The cognitive-kinesthetic method of claim 9, wherein the players are school-age children ranging in age from four years to twelve years old.
